(19) United States
(12) Patent Application Publication
(10) Pub. No.: US 2026/0270255 A1
(43) Pub. Date: Sep. 10, 2026

(54) DEVICE RESET USING A SIGNATURE FROM AN AUTHENTICATION SERVER

(71) Applicant: Hewlett Packard Enterprise Development LP, Spring, TX (US)

(72) Inventors: Logeswari P. Viswanath, Bangalore (IN); Padma Lakshmi Anoop Kulkarni, Bangalore (IN); Luis E. Luciani, JR., Tomball, TX (US)

(21) Appl. No.: 19/231,669

(22) Filed: Jun. 9, 2025

(30) Foreign Application Priority Data
Mar. 5, 2025 (IN) 202511019595

(51) Int. Cl. H04L 9/40

(52) U.S. Cl. CPC H04L 63/0838

(57) ABSTRACT

In some examples, a system receives, as part of a process to reset a target device, a one-time value (OTV) generated by the target device. The system sends the OTV from the system to an authentication server. The system receives, from the authentication server, a signature derived from the OTV. The system provides the signature to a controller in the target device that triggers the reset of the target device.

### BACKGROUND

An electronic device can include a security mechanism that grants access to the electronic device (or a portion of the electronic device) based on a credential supplied by a user of the electronic device. Examples of credentials can include passwords, personal identification numbers (PINs), tokens, or other types of secrets.

### BRIEF DESCRIPTION OF THE DRAWINGS

Some implementations of the present disclosure are described with respect to the following figures.

FIG. 1 is a block diagram of an arrangement including a target device, an agent device, and an authentication server, according to some examples.

FIG. 2 and FIG. 3 are flow diagrams of target device reset processes, according to some examples.

FIG. 4 is a block diagram of a storage medium storing machine-readable instructions according to some examples.

FIG. 5 is a block diagram of a target device according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Some electronic devices have secure-by-default features that prevent deactivation of authentication mechanisms. If a user were to lose the user’s credential for accessing an electronic device that has a secure-by-default feature, then it may not be possible for the user to recover access to the electronic device. The electronic device with the secure-by-default feature may not allow the user or a support technician to perform a manipulation of the electronic device to reset the electronic device to use a default credential (e.g., a credential set at the factory for the electronic device). The manipulation may include physically actuating a maintenance switch to transition the electronic device to a security state in which credential verification is disabled. Another manipulation may involve removing a memory device (e.g., a battery-backed static random access memory or SRAM) to reset a configuration of the electronic device, such as to reset a configuration of a management controller of the electronic device. Another example manipulation may involve a support technician reprogramming a nonvolatile memory to set a default administrative credential to use in accessing the electronic device. In an electronic device with a secure-by-default feature, none of the foregoing manipulations may be possible.

Additionally, if an organization is unable to repair or rework a returned electronic device to reset the electronic device to a factory default state, then the electronic device may have to be discarded which adds to electronic waste.

In accordance with some implementations of the present disclosure, a system can perform a device reset process to reset a target device based on a signature obtained from a remote authentication server, where the signature is derived based on a one-time value generated by the target device. The device reset process may also be based on certificate information from the remote authentication server. The system receives, as part of the device reset process, the one-time value generated by the target device. In some examples, the one-time value is a device identifier produced from an identifier of a hardware component in the target device and a nonce. In other examples, the one-time value may include a nonce. The system that performs the device reset process can be a user device of a user of the target device, a support device of support personnel, or the target device itself. The system sends the one-time value to the authentication server. The system receives, from the authentication server, a signature derived from the one-time value. The system may also receive certificate information from the authentication server. The certificate information may include a certificate chain having one or more certificates. The system provides the signature (and possibly the certificate information) to a controller in the target device that triggers the reset of the target device. The certificate information can include a public key that can be used to validate the signature. Note that the certificate information is not provided by the system to the target device if the target device already stores a public key that can be used to validate the signature.

Techniques or mechanisms according to some examples of the present disclosure improve computer functionality or the relevant technology by enabling access to a target device after a credential used for access to the target device has been lost. By resetting the target device to use a default credential, the default credential can provide access to the target device so that a user can use the target device. Without the ability to reset the target device after the credential is lost, the target device may be disabled and may have to be discarded. In further examples, instead of using the default credential (which itself may not be available), techniques or mechanisms according to some examples of the present disclosure allow for the creation of a new credential to access the target device.

A “one-time value” can refer to a value (e.g., a numeric value, an alphanumeric string, or any other type of value) that is used a single time, i.e., after the value has been used for its designated purpose, the value is not used again. In some examples, the one-time value has an associated expiration time. Once the expiration time expires, the one-time value is no longer valid.

A "signature" refers to data signed by an entity, such as by using a private key. “Certificate information” includes one or more certificates. A certificate includes information to manage identity and security in a computing environment that includes multiple entities that interact with one another. A certificate can be a digital certificate, such as an X.509 certificate according to the X.509 Public Key Infrastructure (PKI) standard. The certificate information may include a certificate chain that has a collection of certificates that are related to one another.

A "reset" of a target device can generally refer to clearing certain information of the target device and transitioning the target device to a prior state. For example, the reset of the target device can reset a credential of the target device to a prior credential or a new credential that is different from an existing credential used to access the target device (or a component of the target device). Resetting the target device may also refer to deleting certain data of the target device so that the data is no longer retrievable.

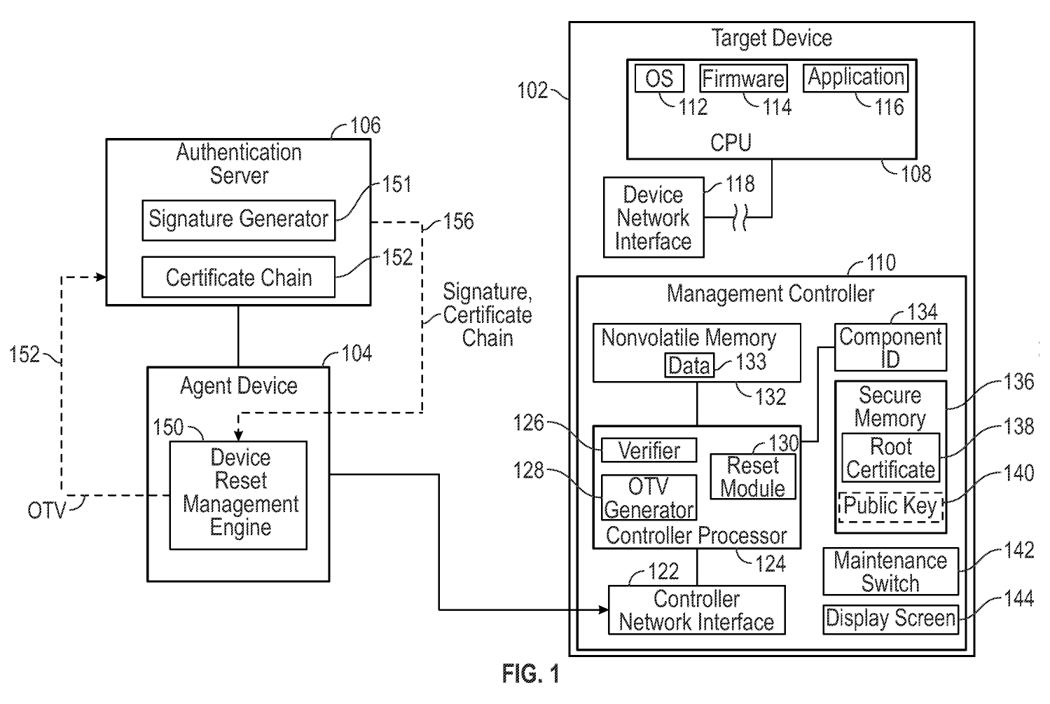

FIG. 1 is a block diagram of an example arrangement that includes a target device 102, an agent device 104, and an authentication server 106. The agent device 104 may be an electronic device of a "customer” who may be the end user of the target device 102. In such examples, the agent device 104 may be referred to as a "customer device." In different examples, the agent device 104 is an electronic device used by support personnel for performing support activities (e.g., repairs, maintenance, recovery, etc.) of the target device 102. In such latter examples, the agent device 104 may be referred to as a "support device."

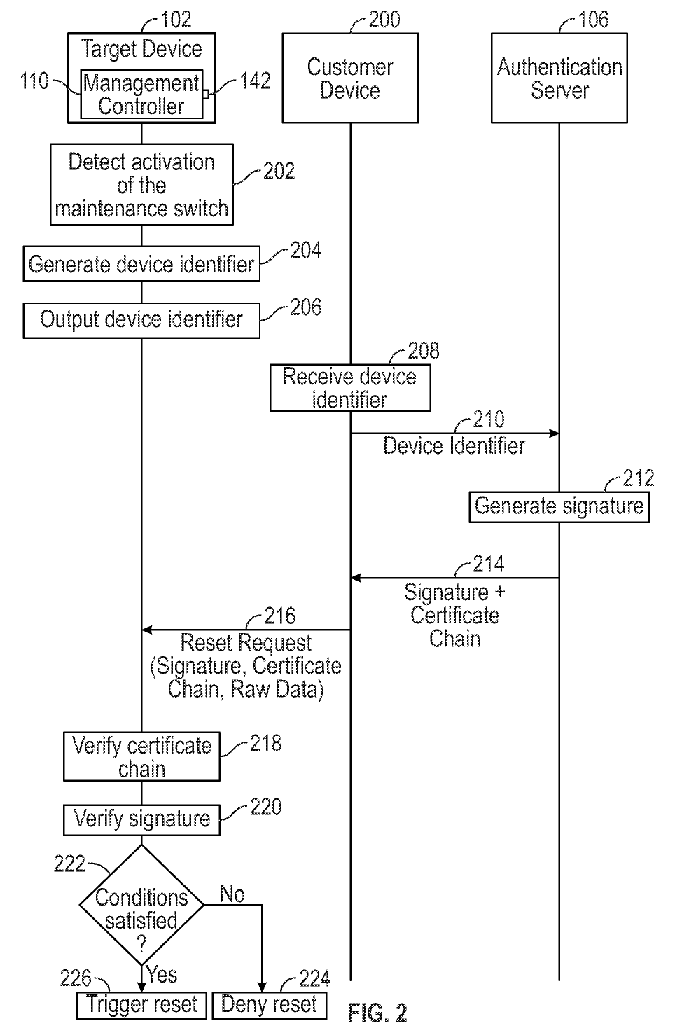

FIG. 2 is a flow diagram of a reset process that performs a reset of the target device 102 using a customer device, while FIG. 3 is a flow diagram of a reset process that resets the target device 102 using a support device. A support device may have certain capabilities not available with a customer device, such as the ability to send a request to obtain information from the target device 102 (discussed further in connection with FIG. 3).

The target device 102 includes a central processing unit (CPU) 108, which has one or more hardware processors. The target device 102 also includes a management controller 110 that is separate from the CPU 108. An example of the management controller 110 is a baseboard management controller (BMC). More generally, the management controller 110 can refer to another type of controller that can perform management tasks with respect to the target device 102. The management controller 110 may be implemented using a single integrated circuit (IC) device or a collection of IC devices (which can be mounted on a circuit board, for example).

The CPU 108 executes primary machine-readable instructions of the target device 102, including an operating system (OS) 112, system firmware 114, and an application program 116. The system firmware 114 can include boot code, such as Basic Input/Output System (BIOS) code or Universal Extensible Firmware Interface (UEFI) code. The primary machine-readable instructions are separate and distinct from machine-readable instructions executed in the management controller 110.

The target device 102 includes a device network interface 118 that can connect to a primary network to allow the target device 102 to communicate with other devices over the primary network. Examples of the primary network can include any or some combination of the following: a local area network (LAN), a wide area network (WAN), a public network such as the Internet, or another type of network.

The primary network to which the device network interface 118 is connected is distinct from a management network 120 that is connected to a controller network interface 122 of the management controller 110. The management network 120 allows other devices, such as the agent device 104, to participate in management tasks with the management controller 110 of the target device 102.

An example of a management task includes resetting the management controller 110. In the ensuing discussion, reference is made to resetting the management controller 110. In other examples, techniques or mechanisms according to some examples of the present disclosure can be used to perform a reset of other parts of a target device. As used here, resetting a target device can refer to resetting a component of the target device to factory defaults or resetting the entire target device.

The management controller 110 includes a controller processor 124 that executes machine-readable instructions of the management controller 110. In some examples, the machine-readable instructions executable by the controller processor 124 include a verifier 126, a one-time value (OTV) generator 128 to generate an OTV, and a reset module 130 to perform a reset of the management controller 110 (or more generally, of the target device 102).

The management controller 110 includes a nonvolatile memory 132 to store data 133. A nonvolatile memory is a memory that maintains its stored content even if power is removed from the memory. The management controller also has a component identifier (ID) 134, which may be stored in the management controller 110. In some examples, the component ID 134 can be stored in the nonvolatile memory 132. In other examples, the component ID 134 can be stored in a separate memory. The component ID 134 may be immutable. For example, once the component ID 134 is written to the management controller 110 during the manufacture of the management controller 110 or the target device 102, the component ID 134 cannot be changed. In some examples, the component ID 134 can identify the management controller 110 or a component of the management controller 110. The component ID 134 may include a serial number, for example. In other examples, the component ID 134 can identify the target device 102. More generally, the component ID 134 identifies a hardware component, which can be an individual component the target device 102, a collection of component the target device 102, or the target device 102 itself.

The management controller 110 also includes a secure memory 136 that stores information protected against unauthorized access. For example, the controller processor 124 can implement a security mechanism to ensure that any access requests for information in the secure memory 136 is from an unauthorized entity.

In some examples, the secure memory 136 can store a root certificate 138. The root certificate 138 verifies the identity of a certificate authority (CA). In some examples, the CA may be the manufacturer of the management controller 110 or the target device 102. The root certificate 138 is signed using a private key of the CA. The authentication server 106 is associated with the CA (e.g., the authentication server 106 is operated by the CA).

In some examples, the secure memory 136 may also store a public key 140, which can be used to verify the root certificate 138. The public key 140 may be part of a public-private key pair that includes the private key of the CA. In other examples, the secure memory 136 does not store the public key 140. In such latter examples, the public key may be included in certificate information, such as a certificate chain produced by the authentication server 106.

The management controller 110 also includes a maintenance switch 142, which is a physical switch or electronic switch on the management controller 110 that can be actuated by a user between a deactivated state and an activated state. When the maintenance switch 142 is actuated to the activated state, the management controller 110 is placed in a maintenance mode. As discussed further below, a user can actuate the maintenance switch 142 to the activated state to prove that the user is in the proximity of the target device 102 when a reset process is initiated by the user. The reset module 130 of the management controller 110 can check the state of the maintenance switch 142 before allowing a reset of the management controller 110 to occur. If the maintenance switch 142 is in the activated state, the reset module 130 can trigger the reset of the management controller 110 provided other conditions (discussed further below) are satisfied. On the other hand, if the maintenance switch 142 is in the deactivated state, the reset module 130 blocks any reset of the management controller 110. Checking the state of the maintenance switch 142 before allowing a reset of the management controller 110 protects against a remote attack in which a remote entity attempts to reset the management controller 110 over a network.

In some examples, the management controller 110 may also include a display screen 144, which can be a relatively small screen to allow a user to view certain information of the management controller 110. In other examples, the management controller 110 can display the information of the management controller 110 on a display device of the target device 102 or an external display device connected to the target device 102. As discussed further below, the display screen 144 (or another display screen) can display an OTV generated by the OTV generator 128.

The agent device 104 includes a device reset management engine 150, which can receive an OTV generated by the OTV generator 128 of the management controller 110. In some examples, the OTV may be entered by a user at the agent device 104. In other examples, the OTV may be received from the management controller 110 over the management network 120.

The device reset management engine 150 transmits (at 152) the OTV, which is received by the authentication server 106. The OTV can be sent to a target recipient by including the OTV in an email sent to a recipient email address, in a text message sent to a recipient phone number, or by any other delivery mechanism (e.g., a network connecting the agent device 104 to the authentication server 106). The target recipient may be the authentication server 106 or another entity different from the authentication server 106. The other entity may forward the OTV to the authentication server 106.

A signature generator 151 in the authentication server 106 generates a signature based on the OTV. The authentication server 106 also stores a certificate chain 154 for the target device 102. The authentication server 106 can send (at 156) the signature and the certificate chain 154 to the agent device 104.

In turn, the device reset management engine 150 in the agent device 104 can send the signature and the certificate chain to the target device 102 for use at the target device 102 for verifying the certificate chain and signature. If verified, the reset module 130 can trigger a reset of the management controller 110.

In alternative examples in which the management controller 110 stores the public key 140, the certificate chain is not sent from the agent device 104 to the management controller 110. In such alternative examples, the authentication server 106 may also not send the certificate chain to the agent device 104.

The certificate chain 154 includes a collection of certificates that are related to one another. For example, the certificate chain 154 may include a device certificate (also referred to as a leaf certificate). The device certificate may contain a public key, such as the CA's public key. The certificate chain 154 also includes a root certificate, which identifies the CA. In some examples, the certificate chain 154 may also include one or more intermediate certificates between the root certificate and the device (leaf) certificate.

In examples where the certificate chain 154 is transmitted from the authentication server 106 to the agent device 104, note that root certificate is not part of the certificate chain actually sent to the agent device 104. Excluding the root certificate from the transmitted certificate chain prevents the root certificate from being exposed.

FIG. 2 is a flow diagram of a reset process that involves the target device 102, a customer device 200, and the authentication server 106. In the example of FIG. 2, the authentication server 106 is available to customers of an organization, including a customer that uses the target device 102. The customer device 200 is an example of the agent device 104 of FIG. 1. The following refers to both FIGS. 1 and 2.

A customer (e.g., an end user) operating the target device 102 may initiate a process to reset the management controller 110. For example, the customer may have forgotten a credential used for access to the management controller 110. As another example, the credential may have been compromised. In some examples, before the customer can initiate the reset process shown in FIG. 2, the customer may have to first contact an organization, such as the manufacturer of the target device 102 or another organization, to first prove that the customer is indeed the owner or other authorized user of the customer device 200. Once the identify of the customer is confirmed (e.g., a password submitted by the customer is valid), the organization can authorize the reset process and can prompt the customer to perform tasks to initiate the reset process.

The customer actuates the maintenance switch 142 of the management controller 110 to the activated state. This is to prove that the customer has physical access to the management controller 110. The verifier 126 executed by the management controller 110 detects (at 202) the actuation of the maintenance switch 142 to the activated state.

The OTV generator 128 executed by the management controller 110 generates (at 204) a device identifier (ID), which is an example of an OTV. The device ID is generated based on the component ID 134 and a nonce produced by the OTV generator 128. In some examples, the nonce is a random number generated by a random number generator of the OTV generator 128. The OTV generator 128 can retrieve the component ID 134 and concatenate the component ID 134 with the nonce to produce the device ID. In other examples, the OTV generator 128 can perform another combination of the component ID 134 and the nonce (e.g., the component ID 134 and the nonce may be fed as inputs to a function that then generates the device ID).

In some examples, the nonce also has an expiration time, which means that the device ID based on the nonce also has an expiration time. For example, the nonce may be valid for a certain time duration (e.g., 10 minutes, 15 minutes, or another time duration). Using the nonce prevents a replay attack in which an attacker captures data and retransmits the captured data to perform unauthorized operations.

The management controller 110 outputs (at 206) the device ID. In some examples, the management controller 110 causes a display of the device ID, such as on the display screen 144 of the management controller 110. In such examples, the customer can enter the device ID at the agent device 104. In other examples, instead of the customer having to manually enter the device ID at the agent device 104, the management controller 110 can send the device ID to the customer device 200, such as over a management network similar to 120 in FIG. 1.

The entered device ID is received (at 208) at the customer device 200, such as by a device reset management engine (similar to 150 in FIG. 1) of the customer device 200. The device reset management engine of the customer device 200 can transmit (at 210) a message containing the device ID to a target recipient. The message may include an email message, a text message, or another type of message. The target recipient may be the authentication server 106 or another entity that can forward the message containing the device ID to the authentication server 106.

In response to receipt of the device ID, the authentication server 106 generates (at 212) a signature based on the device ID. For example, the signature is generated by signing the device ID using the private key of the CA associated with the authentication server 106. The authentication server 106 sends (at 214) the signature and a certificate chain (e.g., 154 in FIG. 1) to the customer device 200.

Note that in other examples, the authentication server 106 may not send the certificate chain to the customer device 200. For example, a public key (e.g., 140 in FIG. 1) of the CA may already be stored at the management controller 110, so that certificate information containing the public key does not have to be sent to the management controller 110.

In response to receiving the signature and the certificate chain from the authentication server 106, the device reset management engine of the customer device 200 sends (at 216) a reset request to the management controller 110, such as over the management network 120 connected to the controller network interface 122 of the management controller 110.

The reset request may be sent through a management interface of the management controller 110, such as a management application program interface (API). The management interface is accessible using the controller network interface 122 of the management controller 110. The management interface is an out-of-band management interface that is separate from another network interface of the target device 102, such as the device network interface 118.

In some examples, the reset request may be in the form of a Redfish call according to the Redfish standard from the Distributed Management Task Force (DMTF), which supports the management of devices. In other examples, the reset request may be sent using a Representational State Transfer (REST) API, or any other type of management interface through which an entity external of the management controller 110 can communicate with the management controller 110.

The reset request contains the signature, the certificate chain, and raw data, where the raw data is cleartext version (unencrypted version) of the device ID. The verifier 126 executed by the management controller 110 verifies (at 218) the certificate chain. As noted above, the certificate chain received from the authentication server 106 does not include the root certificate. The verifier 126 performs the verification of the certificate chain by constructing the full certificate chain and linking the device certificate in the certificate chain through any intermediate certificate(s) to the root certificate 138 stored in the secure memory 136 of the management controller 110. If the device certificate can be successfully linked by the verifier 126 to the root certificate 138 in the management controller's trusted store (the secure memory 136), then that establishes the device certificate can be trusted.

If the certificate chain is verified, the verifier 126 verifies (at 220) the signature included in the reset request. The verification of the signature is accomplished by extracting the CA's public key from the device certificate, and using the public key to decrypt the signature. The decryption of the signature produces data that is compared to the raw data received in the reset request. The data that is produced is the device ID. The produced data should match the raw data. If the produced data and the raw data match, then the signature is verified. On the other hand, if the produced data and the raw data do not match, then the signature is invalid.

In examples where the certificate chain is not sent to the management controller 110, task 218 may be omitted and the verifier 126 can verify the signature using the CA's public key 140 stored in the management controller 110.

The reset module 130 executed by the management controller 110 determines (at 222) whether prerequisite conditions for triggering a reset have been satisfied. The prerequisite conditions include the maintenance switch 142 being in the activated state, and the signature included in the reset request being verified. If the prerequisite conditions are not satisfied (e.g., either the maintenance switch 142 is in the deactivated state or the signature is invalid), the reset module 130 denies (at 224) the reset request and prevents triggering of the reset of the management controller 110.

However, if the prerequisite conditions are satisfied, the reset module 130 triggers (at 226) the reset of the management controller 110. In some examples, the reset of the management controller 110 can reset the management controller 110 to use a default credential. For example, the default credential may be the credential provided on a physical label attached to the management controller 110. Alternatively, the reset of the management controller 110 can prompt the customer to create a new credential to use for accessing the management controller 110. The creation of the new credential may be performed if the default credential is lost or otherwise unavailable (e.g., the physical label has been removed).

In some examples, the reset of the management controller 110 also deletes the data 133 stored in the nonvolatile memory 132 of the management controller 110. Deleting the data 133 prevents an attacker or any other unauthorized entity from accessing the data 133 after the management controller 110 has been reset.

FIG. 3 is a flow diagram of a reset process that involves the target device 102, a support device 300, and the authentication server 106. The support device 300 is an example of the agent device 104 of FIG. 1 and can be used by support personnel to perform support tasks. The support device 300 may have certain privileges that may not be available to the customer device 200 of FIG. 2. For example, the support device 300 may be able to issue commands to the target device 102. Further, the authentication server 106 accessible to the support device 300 may be different from the authentication server accessible to customer devices.

The reset process of FIG. 3 allows for support personnel to reset relative large amounts of target devices (or the management controllers of the target devices) in a more efficient manner. The following refers to both FIGS. 1 and 3.

A support technician operating the support device 300 may initiate a process to reset the management controller 110 in the target device 102. For example, the target device 102 may have been returned to a repair or refurbishment facility to recover the target device 102 or for any other reason.

The support technician actuates the maintenance switch 142 of the management controller 110 to the activated state. This is to prove that the support technician has physical access to the management controller 110. The verifier 126 executed by the management controller 110 detects (at 302) the actuation of the maintenance switch 142 to the activated state.

In response to an input of the support technician, a device reset management (similar to 150 in FIG. 1) of the support device 300 sends (at 304) an OTV request to the management controller 110 to request an OTV from the management controller 110. The OTV request may be sent over the management network 120 through a management interface of the management controller 110. For example, the OTV request may be in the form of a Redfish, a request sent using a REST API, or any other type of management interface.

In response to the OTV request, the OTV generator 128 executed by the management controller 110 generates (at 306) an OTV, which may be a nonce in some examples. In other examples, the OTV may be derived from the nonce. The management controller 110 sends (at 308) the OTV to the support device 300 over the management network 120.

The device reset management engine of the support device 300 can transmit (at 310) a message containing the OTV to a target recipient, which may be the authentication server 106 or another entity that can forward the OTV to the authentication server 106.

In response to receipt of the device ID, the authentication server 106 generates (at 312) a signature based on the OTV. For example, the signature is generated by signing the OTV (e.g., a nonce) using the private key of the CA associated with the authentication server 106. The authentication server 106 sends (at 314) the signature and a certificate chain (e.g., 154 in FIG. 1) to the support device 300.

Note that in other examples, the authentication server 106 may not send the certificate chain to the support device 300. For example, a public key (e.g., 140 in FIG. 1) of the CA may already be stored at the management controller 110, so that certificate information containing the public key does not have to be sent to the management controller 110.

In response to receiving the signature and the certificate chain from the authentication server 106, the device reset management engine of the support device 300 sends (at 316) a reset request to the management controller 110, such as over the management network 120 connected to the controller network interface 122 of the management controller 110.

The reset request contains the signature, the certificate chain, and raw data, where the raw data is cleartext version (unencrypted version) of the OTV. The verifier 126 executed by the management controller 110 verifies (at 318) the certificate chain.

If the certificate chain is verified, the verifier 126 verifies (at 320) the signature included in the reset request. In examples where the certificate chain is not sent to the management controller 110, task 218 may be omitted and the verifier 126 can verify the signature using the CA's public key 140 stored in the management controller 110

The reset module 130 executed by the management controller 110 determines (at 322) whether prerequisite conditions for triggering a reset have been satisfied. The prerequisite conditions include the maintenance switch 142 being in the activated state, and the signature included in the reset request being verified. If the prerequisite conditions are not satisfied (e.g., either the maintenance switch 142 is in the deactivated state or the signature is invalid), the reset module 130 denies (at 324) the reset request and prevents triggering of the reset of the management controller 110.

However, if the prerequisite conditions are satisfied, the reset module 130 triggers (at 326) the reset of the management controller 110. In some examples, the reset of the management controller 110 can reset the management controller 110 to use a default credential. In some examples, the reset of the management controller 110 also deletes the data 133 stored in the nonvolatile memory 132 of the management controller 110.

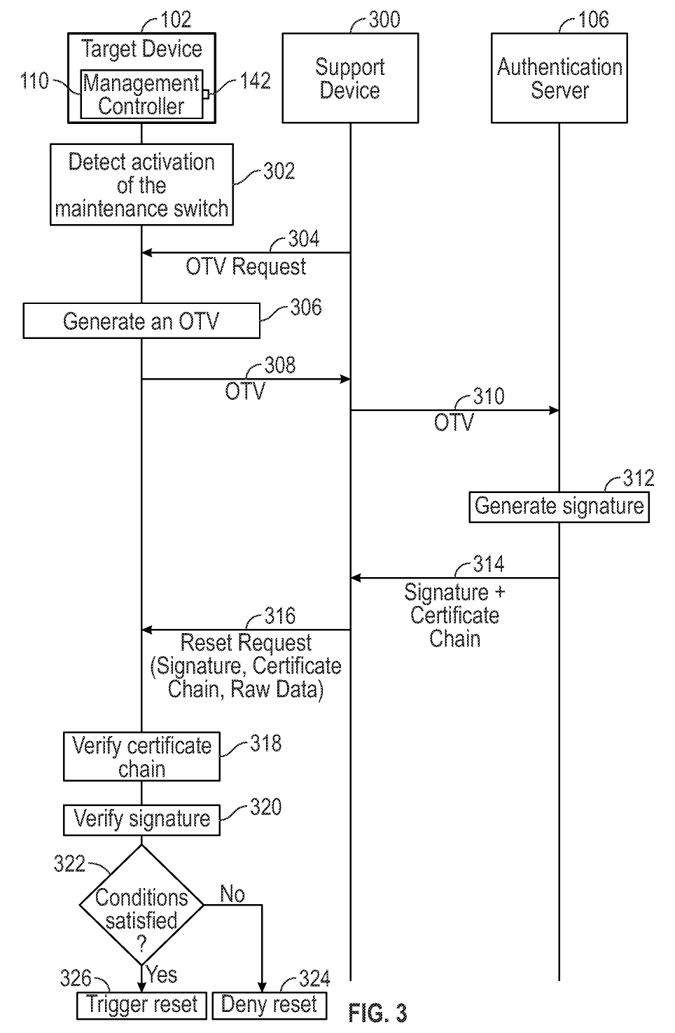

FIG. 4 is a block diagram of a non-transitory machine-readable or computer-readable storage medium 400 storing machine-readable instructions that upon execution cause a system to perform various tasks. The system may be the agent device 104 or the target device 102 of FIG. 1.

The machine-readable instructions include OTV reception instructions 402 to receive, at the system as part of a process to reset the target device, an OTV generated by the target device. The OTV may be a device ID based on a nonce and a component ID, or alternatively, the OTV may include the nonce.

The machine-readable instructions include OTV sending instructions 404 to send the OTV from the system to an authentication server (e.g., 106 in FIG. 1). In some examples, the OTV may be sent directly to the authentication server, or the OTV may be sent to another recipient that forwards the OTV to the authentication server.

The machine-readable instructions include signature reception instructions 406 to receive, at the system from the authentication server, a signature derived from the OTV. The signature includes signed data derived by signing the OTV (or the OTV in combination with a further value) with a private key of a CA.

The machine-readable instructions include signature provision instructions 408 to provide the signature to a controller in the target device that triggers the reset of the target device. The controller may be the management controller 110 of FIG. 1, for example.

In some examples, the reset of the target device is triggered further responsive to a switch on the target device being activated by a user. The switch may be the maintenance switch 142 of FIG. 1, for example.

In some examples, the system can receive certificate information from the authentication server. The certificate information can include a certificate chain. The reset of the target device is based on a verification of the certificate information and a verification of the signature by the controller in the target device.

In some examples, the certificate information contains a public key used as part of the verification of the signature by the controller in the target device.

In some examples, the reset of the target device includes resetting a credential of the target device.

In some examples, the reset of the target device includes deleting data stored in the target device.

In some examples, the system can send, to the controller in the target device, a reset request through a management interface, the reset request including the signature and possibly the certificate information. The reset request may further include raw data including an unencrypted version of the OTV.

In some examples, the management interface is an out-of-band management interface of the controller.

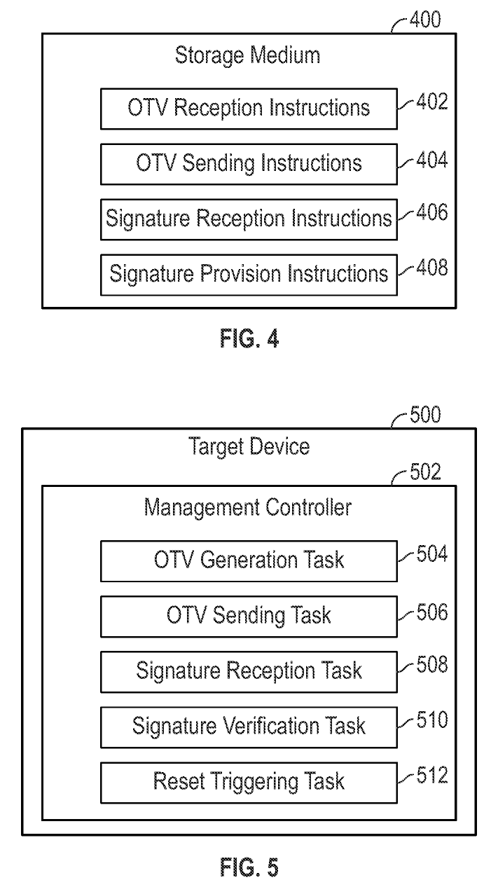

FIG. 5 is a block diagram of a target device 500 according to some examples of the present disclosure. The target device 102 of FIG. 1 is an example of the target device 500.

The target device 500 includes a management controller 502 to perform various tasks. The management controller 502 may be a BMC or another type of management controller.

The tasks of the management controller 502 include an OTV generation task 504 to generate an OTV for a process to reset the target device 500. The OTV generated may include a device ID or a nonce.

The tasks of the management controller 502 include an OTV sending task 506 to send the OTV from the target device 500 to a system. The system may be the agent device 104 of FIG. 1, for example.

The tasks of the management controller 502 include a signature reception task 508 to receive, at the target device 500 from the system, a signature derived from the OTV by an authentication server. The authentication server receives the OTV that is sent by the system, and the authentication server signs the OTV to generate the signature.

The tasks of the management controller 502 include a signature verification task 510 to verify the signature. The verification of the signature can use a public key included in certificate information from the authentication server, or a public key stored by the management controller 502.

The tasks of the management controller 502 include a reset triggering task 512 to trigger the reset of the target device 500 based on verifying the signature.

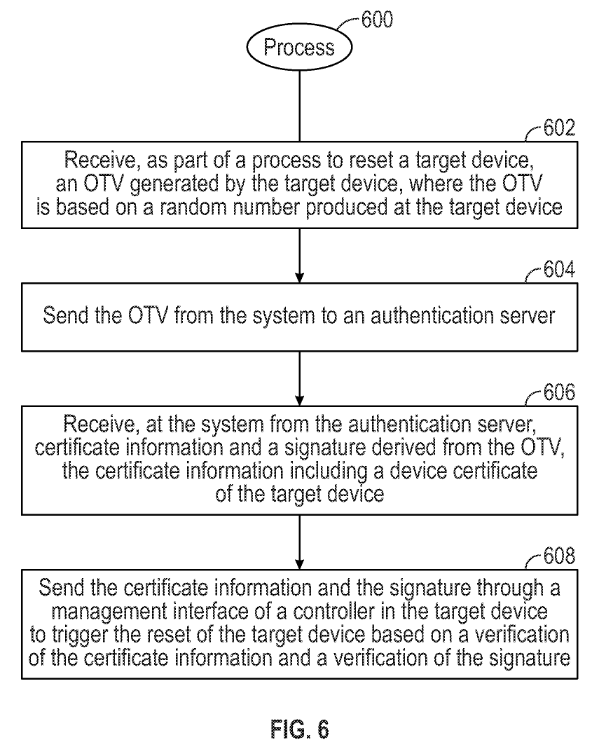

FIG. 6 is a flow diagram of a process 600 according to some examples of the present disclosure. The process 600 may be performed by a system including the agent device 104 and/or the target device 102 of FIG. 1.

The process 600 includes receiving (at 602), as part of a process to reset the target device, an OTV generated by the target device, where the OTV is based on a random number produced at the target device. The OTV may include the random number or a combination of the random number and another value, such as a component ID.

The process 600 includes sending (at 604) the OTV from the system to an authentication server.

The process 600 includes receiving (at 606), at the system from the authentication server, certificate information and a signature derived from the OTV, the certificate information including a device certificate of the target device. The device certificate includes a public key of a CA, for example.

The process 600 includes sending (at 608) the certificate information and the signature through a management interface of a controller in the target device to trigger the reset of the target device based on a verification of the certificate information and a verification of the signature.

FIGS. 2, 3, and 6, are flow diagrams of processes including specific orders of tasks. In other examples, the tasks may be performed in a different order, some tasks may be omitted, and other tasks may be added.

A "BMC" can refer to a specialized service controller that monitors the physical state of an electronic device using sensors and communicates with a remote management system (that is remote from the electronic device) through an independent "out-of-band" connection. The BMC can perform management tasks to manage components of the electronic device. Examples of management tasks that can be performed by the BMC can include any or some combination of the following: power control to perform power management of the electronic device (such as to transition the electronic device between different power consumption states in response to detected events), thermal monitoring and control of the electronic device (such as to monitor temperatures of the electronic device and to control thermal management states of the electronic device), fan control of fans in the electronic device, system health monitoring based on monitoring measurement data from various sensors of the electronic device, remote access of the electronic device (to access the electronic device over a network, for example), remote reboot of the electronic device (to trigger the electronic device to reboot using a remote command), system setup and deployment of the electronic device, system security to implement security procedures in the electronic device, and so forth.

In some examples, the BMC can provide so-called "lights-out" functionality for the electronic device. The lights out functionality may allow a user, such as a systems administrator, to perform management operations on the electronic device even if an OS is not installed or not functional on the electronic device.

Moreover, in some examples, the BMC can run on auxiliary power provided by an auxiliary power source; as a result, the electronic device does not have to be powered on to allow the BMC to perform the BMC's operations. The auxiliary power source is separate from a primary power supply that supplies powers to other components (e.g., a main processor, a memory, an I/O device, etc.) of the electronic device.

A "controller" can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a "controller" can refer to a combination of one or more hardware processing circuits and machine-readable instructions (software and/or firmware) executable on the one or more hardware processing circuits.

A hardware processor can include a microprocessor, a core of a multi-core microprocessor, a microcontroller, a programmable integrated circuit, a programmable gate array, or another hardware processing circuit. Machine-readable instructions executable on a hardware processor can refer to the instructions executable on a single hardware processor or the instructions executable on multiple hardware processors.

A storage medium (e.g., 400 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term "a," "an," or "the" is intended to include the plural forms as well, unless the context clearly indicates otherwise. Also, the term "includes," "including," "comprises," "comprising," "have," or "having" when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
receive, at the system as part of a process to reset a target device, a one-time value generated by the target device;
send the one-time value from the system to an authentication server;
receive, at the system from the authentication server, a signature derived from the one-time value; and
provide the signature to a controller in the target device that triggers the reset of the target device.

2. The non-transitory machine-readable storage medium of claim 1, wherein the system comprises an electronic device separate from the target device, and the non-transitory machine-readable storage medium comprising the instructions are part of the electronic device.

3. The non-transitory machine-readable storage medium of claim 1, wherein the one-time value comprises an identifier based on an identifier associated with the target device, and a nonce generated at the target device.

4. The non-transitory machine-readable storage medium of claim 3, wherein the identifier associated with the target device comprises an identifier of a hardware component comprising the controller.

5. The non-transitory machine-readable storage medium of claim 1, wherein the one-time value comprises a nonce generated at the target device.

6. The non-transitory machine-readable storage medium of claim 1, wherein the reset of the target device is triggered further responsive to a switch on the target device being activated.

7. The non-transitory machine-readable storage medium of claim 1, wherein the instructions upon execution cause the system to:
receive, at the system, certificate information from the authentication server,
wherein the reset of the target device is based on verification of the certificate information and verification of the signature by the controller in the target device.

8. The non-transitory machine-readable storage medium of claim 7, wherein the certificate information contains a public key used as part of the verification of the signature by the controller in the target device.

9. The non-transitory machine-readable storage medium of claim 1, wherein the reset of the target device comprises resetting a credential of the target device.

10. The non-transitory machine-readable storage medium of claim 1, wherein the reset of the target device comprises deleting data stored in the target device.

11. The non-transitory machine-readable storage medium of claim 1, wherein the one-time value has an expiration time.

12. The non-transitory machine-readable storage medium of claim 1, wherein the instructions upon execution cause the system to:
send, from the system to the controller in the target device, a reset request through a management interface, the reset request comprising the signature.

13. The non-transitory machine-readable storage medium of claim 12, wherein the management interface is an out-of-band management interface of the controller.

14. The non-transitory machine-readable storage medium of claim 12, wherein the reset request further comprises raw data including the one-time value.

15. A target device comprising:
a management controller to:
generate a one-time value for a process to reset the target device;
send the one-time value from the target device to a system;
receive, at the target device from the system, a signature derived from the one-time value by an authentication server;
verify the signature; and
based on verifying the signature, trigger the reset of the target device.

16. The target device of claim 15, further comprising:
a maintenance switch actuatable by a user between a deactivated state and an activated state,
wherein the reset of the target device is triggered further based on the maintenance switch being in the activated state.

17. The target device of claim 15, wherein the one-time value is based on a random number generated by the management controller.

18. The target device of claim 15, wherein the management controller is to receive certificate information including a public key from the authentication server, and where the verifying of the signature uses the public key.

19. A method comprising:
receiving, at a system comprising a hardware processor as part of a process to reset a target device, a one-time value generated by the target device, the one-time value based on a random number produced at the target device;
sending the one-time value from the system to an authentication server;
receiving, at the system from the authentication server, certificate information and a signature derived from the one-time value, the certificate information comprising a device certificate of the target device; and
sending the certificate information and the signature through a management interface of a controller in the target device to trigger the reset of the target device based on a verification of the certificate information and a verification of the signature.

20. The method of claim 19, wherein the reset of the target device comprises a reset of a credential for the target device.
